(19) United States
(12) Patent Application Publication
(10) Pub. No.: US 2025/0065451 A1
(43) Pub. Date: Feb. 27, 2025

(54) WELD FIXTURE AND RELATED METHOD

(71) Applicant: GM Global Technology Operations LLC, Detroit, MI (US)

(72) Inventors: Jerome Longtine, Marine City, MI (US); Rolando Vera-Calzada, Commerce Twp., MI (US); Md Wahidul Islam, Madison Heights, MI (US); Kyle J. Sinko, Rochester, MI (US); Odilon Firmino Maillo, Warren, MI (US); Mark Engel, Clay Township, MI (US)

(73) Assignee: GM Global Technology Operations LLC, Detroit, MI (US)

(21) Appl. No.: 18/453,600

(22) Filed: Aug. 22, 2023

(51) Int. Cl. B23K 37/04; B25B 5/10

(52) U.S. Cl. CPC B23K 37/0435; B23K 37/0408; B25B 5/10

(57) ABSTRACT

A fixture for supporting a tool includes a housing defining an aperture receiving a projection of the fixture, a shaft extending through the aperture and into the housing, the shaft including a series of external threads, and an adjustment dial threaded onto the threads of the shaft and including an engagement surface in contact with a surface of the projection, the adjustment dial configured to adjust a position of the tool relative to the housing when the adjustment dial is rotated relative to and moves along the shaft.

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against present disclosure.

The present disclosure relates generally to fixtures and more particularly to a fixture for use with a projection welder.

Fixtures are often used in manufacturing settings to hold a tool or workpiece during a manufacturing operation. For example, a fixture may be used in an automotive setting to hold two or more pieces of sheet metal relative to one another and relative to a spot welder. The fixture may hold the pieces of sheet metal in a desired position relative to one another to ensure the desired relative position is maintained during welding by the spot welder.

Such fixtures may also be used in conjunction with projection welders to hold a workpiece relative to a projection welder. The workpiece may be held relative to the projection welder to allow the projection welder to attach a component to the workpiece. For example, a threaded nut or stud may be welded to the workpiece by the projection welder while the workpiece is held in place relative to the component and the projection welder by the fixture. The fixture may include a component-specific tool that is received by the fixture and interfaces with the workpiece. The component-specific tool may be designed to interface with the specific workpiece to properly position the workpiece relative to the projection welder during assembly. When the projection welder is used in conjunction with a different workpiece, a different tool may be used with the fixture to allow the fixture to properly position the tool and, thus, the workpiece, relative to the projection welder.

When one or more tools are used with a fixture, adjustments to the fixture are often required to ensure that the specific tool is properly positioned relative to the projection welder. Such adjustments may include adjusting a height of the fixture, adjusting a fitting associated with the fixture that receives the specific tool, and/or adjusting a position of the projection welder relative to the fixture. While all of the foregoing processes help to ensure that the tool and the workpiece are properly positioned relative to the projection welder during manufacturing, the foregoing adjustments each require time to be properly performed. Accordingly, when a fixture is used with multiple tools, switching between tools can be a time- consuming process, which negatively affects manufacturing efficiency. Further, if the adjustments to the fixture, tool, and/or projection welder are not properly performed, errors in manufacturing may occur. For example, if a height of the tool relative to the projection welder is not properly set, a resulting weld performed by the projection welder may not adhere a component to a workpiece at a desired location.

In addition to the foregoing, even when a tool is properly attached to a fixture, a resulting weld may not be performed properly if the projection welder is not maintained. Specifically, projection welders require maintenance after performing a certain number of welds, which often includes removing an amount of material from a tip of the projection welder. While removing material from the tip of the welder allows the projection welder to continue operation without having to replace the tip, such removal of material can affect a position of a workpiece while held in a tool relative to the tip of the projection welder, which may result in an ineffective weld.

In order to avoid an ineffective weld, the fixture associated with the tool may be adjusted to account for the material removed from the tip of the projection welder. Accounting for the removal of the material from the tip of the projection welder often requires that the fixture be adjusted using tools and shims to ensure that the fixture and, thus, the resulting tool and workpiece supported by the fixture, are properly positioned relative to the projection welder during manufacturing. While such adjustments to the fixture adequately adjust the position of the fixture relative to the projection welder, such adjustments are time consuming and, as a result, reduce manufacturing efficiency.

Based on the foregoing, conventional fixtures adequately support tools during manufacturing processes to allow the tools to hold a workpiece in a proper position relative to a welder. However, adjusting such fixtures to account for different tools and/or to account for adjustments made to an external welder such as, for example, a projection welder, are time consuming and result in a loss of manufacturing efficiency. Accordingly, a need exists for a fixture that can be easily adjusted to account for different tools and for changes that are made to a welder used in conjunction with the fixture.

### SUMMARY

In one configuration, a fixture for supporting a tool is provided and includes a housing defining an aperture receiving a projection of the fixture, a shaft extending through the aperture and into the housing, the shaft including a series of external threads, and an adjustment dial threaded onto the threads of the shaft and including an engagement surface in contact with a surface of the projection, the adjustment dial configured to adjust a position of the tool relative to the housing when the adjustment dial is rotated relative to and moves along the shaft.

The fixture may include one or more of the following optional features. For example, the shaft may include a first end projecting from the aperture and a second end disposed at an opposite end of the shaft than the first end and secured to the housing. A knob may be threaded onto the shaft at the first end. The knob may be configured to move along the shaft when rotated relative to the shaft, the knob moving in a direction toward the adjustment dial when rotated in a first direction to clamp the tool between the knob and the engagement surface when the adjustment dial is in a predetermined position relative to the housing.

In one configuration, at least one of the housing and the adjustment dial may be formed from a thermoplastic. The thermoplastic may be Acrylonitrile Styrene Acrylate (ASA) and/or at least one of the housing and the adjustment dial may be formed via an additive manufacturing process.

A set screw supported by the housing may be configured to engage an outer perimeter surface of the adjustment dial to fix a position of the adjustment dial relative to the housing.

In one configuration, the aperture may include a shape that matingly conforms to a cross-sectional shape of the projection. Additionally, a portion of the shaft may extend through the tool proximate to the aperture.

In another configuration, a method for adjusting a position of a tool relative to a fixture includes providing a housing with an aperture, extending a shaft through the aperture and into the housing, the shaft including a series of external threads, and threading an adjustment dial onto the threads of the shaft, the adjustment dial including an engagement surface. The method further includes extending a projection of the fixture through the aperture and into the housing, contacting a distal end of the projection with the engagement surface of the adjustment dial, rotating the adjustment dial relative to the housing to move the adjustment dial along the shaft, and moving the tool relative to the housing along with the adjustment dial to adjust a position of the tool relative to the housing.

The method may include one or more of the following optional features. For example, the method may include providing the shaft with a first end projecting from the aperture and a second end disposed at an opposite end of the shaft than the first end and secured to the housing. Further, a knob may be threaded onto the shaft at the first end. The knob may be rotated relative to the shaft to move the knob along the shaft, the knob moving in a direction toward the adjustment dial when rotated in a first direction to clamp the tool between the knob and the engagement surface when the adjustment dial is in a predetermined position relative to the housing.

In one configuration, the method may include forming at least one of the housing and the adjustment dial from Acrylonitrile Styrene Acrylate (ASA). Further, at least one of the housing and the adjustment dial may be formed via an additive manufacturing process.

In one configuration, the method may include forming at least one of the housing and the adjustment dial from a thermoplastic. Forming at least one of the housing and the adjustment dial from a thermoplastic may include forming at least one of the housing and the adjustment dial from Acrylonitrile Styrene Acrylate (ASA). Further, at least one of the housing and the adjustment dial may be formed via an additive manufacturing process.

A set screw may be engaged with an outer perimeter surface of the adjustment dial to fix a position of the adjustment dial relative to the housing.

In one configuration, the method may include providing the aperture with a shape that matingly conforms to a cross-sectional shape of the projection. Additionally or alternatively, a portion of the shaft may extend through the tool proximate to the aperture.

### BRIEF DESCRIPTION OF THE DRAWINGS

The drawings described herein are for illustrative purposes only of selected configurations and are not intended to limit the scope of the present disclosure.

FIG. 1 is a perspective view of a fixture in accordance with the principles of the present disclosure:

FIG. 2 is an exploded view of the fixture of FIG. 1:

FIG. 3 is a cross-sectional view of the fixture of FIG. 1 taken along Line 3-3 of FIG. 1:

FIG. 4 is a perspective view of the fixture of FIG. 1 shown in conjunction with a tool and a cut-away view of a workpiece:

FIG. 5 is a side view of the fixture of FIG. 4 showing the fixture, the tool, and the workpiece relative to a projection welder:

FIG. 6 is a top view of the fixture of FIG. 4 showing the tool of FIG. 4 used in conjunction with the fixture: and

FIG. 7 is a top view of another fixture in accordance with the principles of the present disclosure used in conjunction with a tool.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including.” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to.” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to.” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first.” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC): a digital, analog, or mixed analog/digital discrete circuit: a digital, analog, or mixed analog/digital integrated circuit: a combinational logic circuit: a field programmable gate array (FPGA): a processor (shared, dedicated, or group) that executes code: memory (shared, dedicated, or group) that stores code executed by a processor: other suitable hardware components that provide the described functionality: or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices: magnetic disks, e.g., internal hard disks or removable disks: magneto optical disks: and CD ROM and DVD-ROM disks. The processor and the memory can be supplemented by. or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well: for example, feedback provided to the user can be any form of sensory feedback, e.g., visual feedback, auditory feedback, or tactile feedback: and input from the user can be received in any form, including acoustic, speech, or tactile input. In addition, a computer can interact with a user by sending documents to and receiving documents from a device that is used by the user: for example, by sending web pages to a web browser on a user's client device in response to requests received from the web browser.

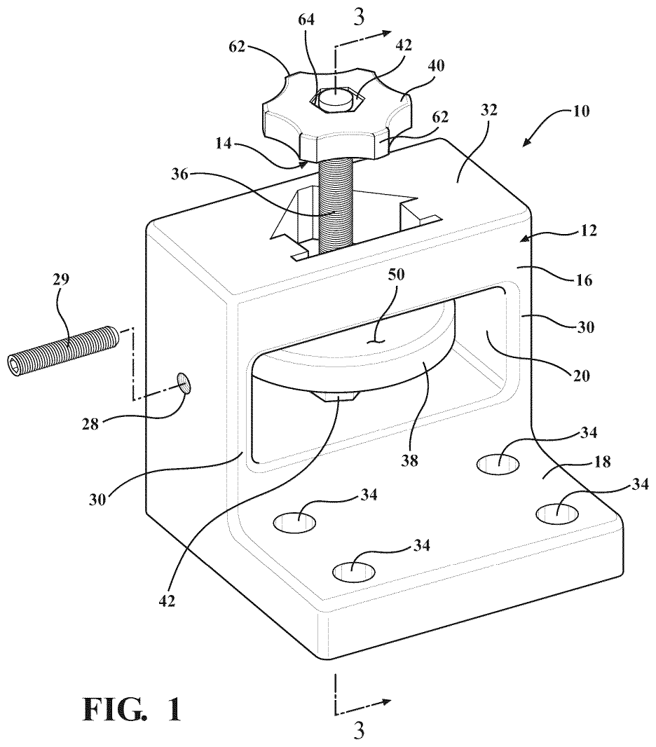

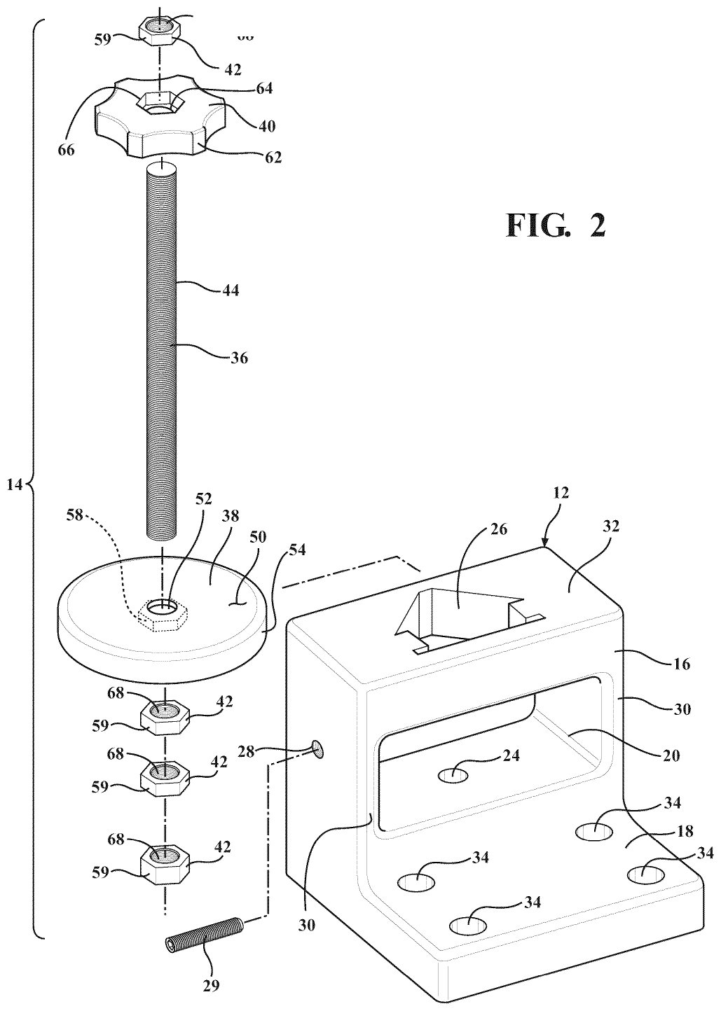

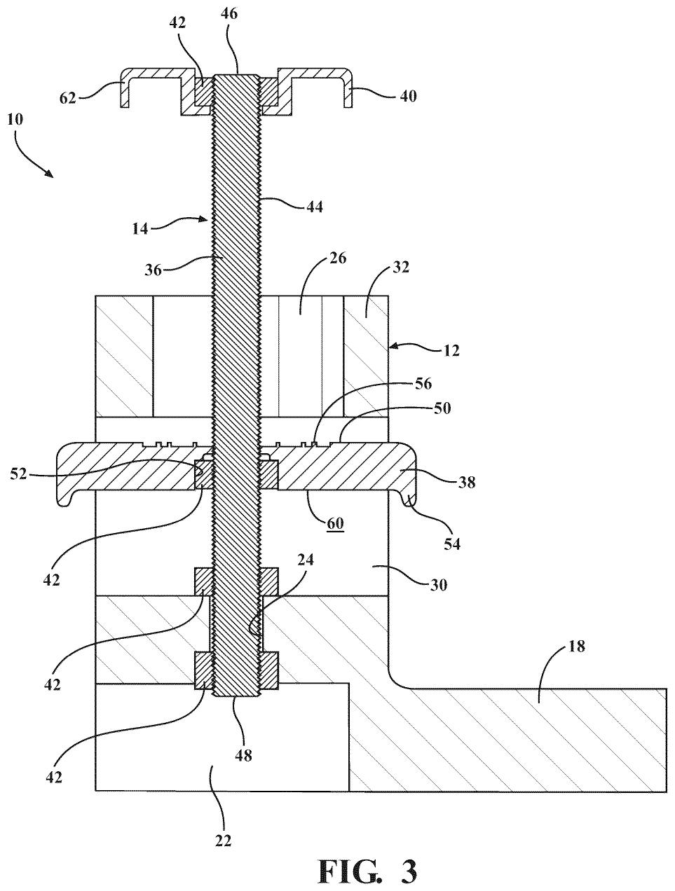

With particular reference to FIGS. 1-3, a fixture 10 is provided. The fixture 10 includes a receiver 12 and an adjustment assembly 14 rotatable supported by the receiver 12. The receiver 12 includes a main body 16 and flange 18 extending from the main body 16. As shown, the flange 18 may extend from a base of the main body 16 and is positioned substantially perpendicular to the main body 16. The main body 16 includes an opening 20 extending through the main body 16, a recess 22 (FIG. 3), a bore 24 extending between and connecting the opening 20 and the recess 22, an aperture 26, and a threaded through-hole 28 in communication with the opening 20. The opening 20 is defined by a pair of opposing side walls 30 of the main body 16, which are connected to one another by a top wall 32. As shown in FIGS. 1 and 2, the sidewalls 30 oppose one another across a width of the main body 16 and extend substantially parallel to one another with one of the sidewalls 30 including the through hole 28 formed through a thickness thereof.

The top wall 32 of the main body extends between and joins the sidewalls 30 and extends along a width of the main body 16. The top wall 32 extends substantially perpendicular to the sidewalls 30 and includes the aperture 26 formed therethrough. Accordingly, the opening 20) is accessible from the top wall 32 via the aperture 26. As shown in FIGS. 1 and 2. the aperture 26 is aligned with the bore 24 such that a center of the aperture 26 is substantially aligned with a center of the bore 24.

As described above, the flange 18 extends from the main body 16 in a direction substantially perpendicular to the main body 16. As shown in FIGS. 1-3, the flange 18 includes a series of apertures 34 formed through the thickness of the flange 18, which may be used to secure the flange 18 and, thus, the main body 16 to an external structure (FIG. 5).

With continued reference to FIGS. 1-3, the adjustment assembly 14 is shown as including a threaded shaft or rod 36, an adjustment dial 38, a knob 40, and a series of nuts 42. As shown, the threaded rod 36 includes a series of threads 44 extending along a length of the threaded rod 36 from a first end 46 to a second end 48. The adjustment dial 38 is threaded onto the threaded rod 36 and includes an engagement surface 50, an aperture 52, and a flange 54 extending around an outer perimeter of the adjustment dial 38. The engagement surface 50 may be substantially planar (FIG. 2) or, alternately, may include a series of engagement features 56 (FIG. 3) that aid in engagement with an external tool, as will be described in greater detail below: The aperture 52 is centrally located on the adjustment dial 38 and includes a series of flats 58 for engagement with one of the nuts 42. The aperture 52 may additionally include an angular grove (not shown) surrounding the aperture 52, which aides in attaching one of the nuts 42 to the adjustment dial 38 within the aperture 52. Specifically, one of the nuts 42 may be received within the aperture 52 of the adjustment dial 38 such that outer flats 59 of one of the nuts 42 oppose and engage respective flats 58 defined by the aperture 52. The nut 42 may be retained within the aperture 52 by an adhesive to fix the nut 42 for rotation with the adjustment dial 38.

The flange 54 extends around a perimeter of the adjustment dial 38 and in a direction away from a bottom surface 60 of the adjustment dial 38 (FIG. 3). As such, and as shown in FIG. 3, the flange 54 extends in a direction away from the top wall 32 of the main body 16 once the adjustment assembly 14 is assembled to the receiver 12. The flange 54 provides a grip for use in manipulating and rotating the adjustment dial 38 relative to and along the threaded rod 36.

The knob 40 includes a series of gripping features 62 extending around an outer perimeter of the knob 40 and an aperture 64 formed through the knob 40. The aperture 64 is centrally located on the knob 40 and includes a series of flats 66. As with the flats 58 of the adjustment dial 38, the flats 66 of the knob 40 engage respective flats 59 of one of the nuts 42 when the nut 42 is received within the aperture 64 of the knob 40. Further, the aperture 64 of the knob 40 may include a grove (not shown) that encircles the aperture 64 in a similar fashion as the aperture 52 of the adjustment dial 38 to provide increased surface area for adhesive to bond the nut 42 to the knob 40. Once the adhesive bonds the nut 42 to the knob 40, the nut 42 is fixed for rotation with the knob 40.

With particular reference to FIGS. 1-3, the adjustment assembly 14 is shown as being assembled to and received by the receiver 12. As shown, the nut 42 attached to the adjustment dial 38 is threaded onto the threads 44 of the threaded rod 36 such that when a force is exerted on the adjustment dial 38 to rotate the adjustment dial 38 relative to the threaded rod 36, threads 68 associated with the nut 42 attached to the adjustment dial 38 engage the threads 44 of the threaded rod 36, thereby causing the adjustment dial 38 to move along the threaded rod 36. Specifically, the adjustment dial 38 moves along the threaded rod 36 between the first end 46 and the second end 48 which, in turn, causes the adjustment dial 38 to either move closer to the first end 46 or away from the first end 46 depending on the direction of rotation (clockwise or counterclockwise) when the adjustment dial 38 is rotated relative to the threaded rod 36.

In a similar fashion, the knob 40 is threaded onto the threaded rod 36 at the first end 46 via engagement between the threads 68 of the nut 42 attached to the knob 40 and the threads 44 of the rod 36. As with the adjustment dial 38, when a rotational force is applied to the knob 40 at the gripping features 62, the knob 40 will either move towards or away from the first end 46 of the threaded rod 36 depending on the direction of rotation of the knob 40 (i.e., clockwise or counterclockwise).

When the threaded rod 36 is initially assembled to the receiver 12, the threaded rod 36 is inserted into the aperture 26 of the main body 16. At this point, the adjustment dial 38 may be positioned relative to the threaded rod 36 within the opening 20 such that the second end 48 of the threaded rod 36 opposes the engagement surface 50 of the adjustment dial 38. The second end 48 of the threaded rod 36 may be inserted into the aperture 52 of the adjustment dial 38 to allow the threads 68 of the nut 42 attached to the adjustment dial 38 to engage the threads 44 of the threaded rod 36. At this point, a rotational force may be applied to the adjustment dial 38 at the flange 54 to move the adjustment dial 38 in a direction away from the second end 48 of the threaded rod 36 and towards the first end 46 of the threaded rod 36.

After the adjustment dial 38 is threaded onto the threaded rod 36 and is moved along the threaded rod 36 sufficiently away from the second end 48, one of the nuts 42 may be threaded onto the threaded rod 36 at the second end 48 may be moved in a direction towards the adjustment dial 38, as shown in FIG. 3. Once the nut 42 is moved sufficiently along the threaded rod 36 towards the adjustment dial 38, the second end 48 of the threaded rod 36 may be inserted into and through the bore 24 of the main body 16. The second end 48 may extend from the bore 24 and may receive one of the nuts 42. The nut 42 threads onto the threads 44 of the threaded rod 36 within the recess 22 to secure the threaded rod 36 to the main body 16. During assembly, the nut 42 disposed within the opening 20 may be rotated in a direction toward the second end 48 while the nut 42 disposed within the recess 22 may be rotated in a direction away from the second end 48 to attach the threaded rod 36 to the main body 16. In so doing. a position of the threaded rod 36 relative to the main body 16 is maintained by the threaded nut 42 disposed within the recess 22 and the threaded nut 42 disposed within the opening 20.

Once the threaded rod 36 is attached to the main body 16, the first end 46 of the threaded rod 36 may receive the nut 42 associated with the knob 40. Rotation of the knob 40 relative to the threaded rod 36 causes the threads 68 of the nut 42 associated with knob 40 to engage the threads 44 of the threaded rod 36 which, in turn, causes the knob 40 to move in a direction away from the first end 46 of the threaded rod 36 and in a direction toward the top wall 32 of the main body 16. As will be described in greater detail below, movement of the knob 40 in a direction toward the top wall 32 allows the knob 40 to secure an external structure relative to the main body 16.

In one configuration, the threaded rod 36 and the nuts 42 may be formed from a ridged material such as, for example, metal. Each of the other components associated with the receiver 12 and the adjustment assembly 14 may be formed from an additive manufacturing process and, as such, may be formed from a lighter material than the threaded rod 36 and the nuts 42. For example, the receiver 12, the adjustment dial 38, and the knob 40 may all be formed via an additive manufacturing process such as 3D printing and may be formed from a synthetic, amorphous thermoplastic such as Acrylonitrile Styrene Acrylate (ASA). Forming the receiver 12, the adjustment dial 38, and the knob 40 from ASA via an additive manufacturing process allows these components to be formed from a relatively lightweight material which, in turn, improves manufacturing ease and efficiency during setup and assembly. Furthermore, using an additive manufacturing process to form these components, decreases the time required to manufacture each component.

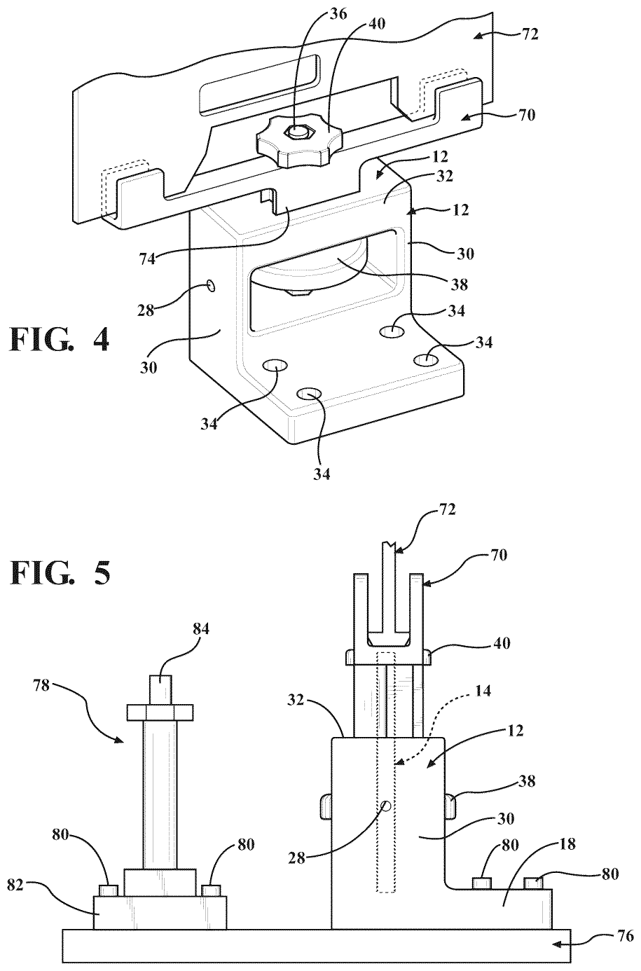

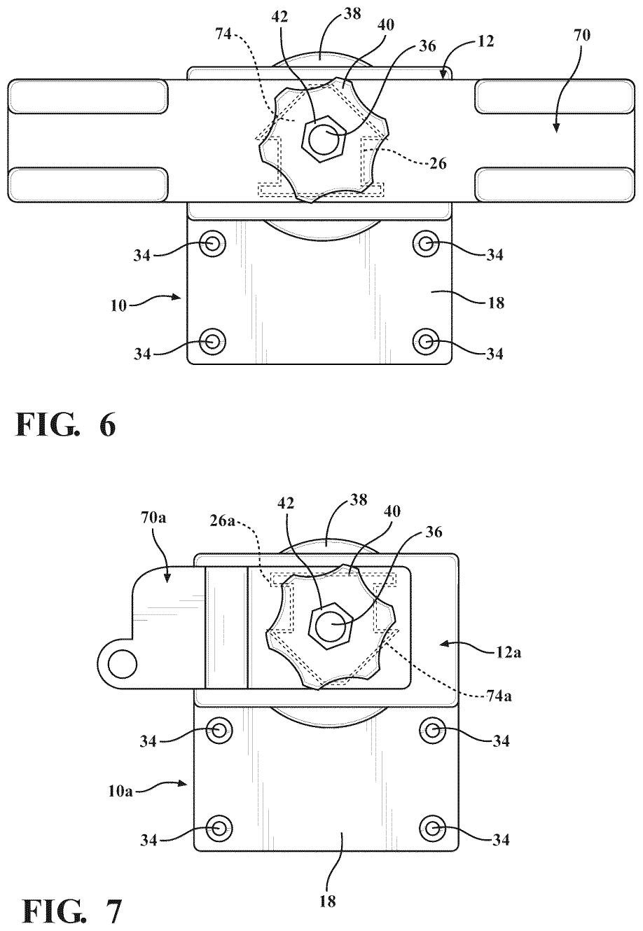

With particular reference to FIGS. 4-7, operation of the fixture 10 will be described in detail. As shown in FIG. 4, the fixture 10 may be used in conjunction with a tool 70 to properly position a workpiece 72 relative to the fixture 10. The tool 70 may be attached to the fixture 10 by removing the knob 40 from the threaded rod 36. When the knob 40 is removed from the threaded rod 36, the tool 70 may be inserted into the aperture 26 formed in the top wall 32 of the main body 16. As shown in FIG. 2, the aperture 26 includes a distinctive shape that is specific to a shape of a projection 74 of the tool 70. Accordingly, the projection 74 can only be inserted into the aperture 26 in a single orientation. In so doing, the interface between the projection 74 and the aperture 26 of the main body 16 ensures that the tool 70 may only be positioned relative to the main body 16 and, thus, the fixture 10 in a single position. For example, if the tool 70 were rotated 90 degrees (90) relative to the view shown in FIG. 4, the projection 74 would not mate with the aperture 26 of the main body 16 and would therefore be prevented from being attached to the fixture 10. Only when the projection 74 is positioned in the orientation shown in FIG. 4 will the projection 74 properly engage the aperture 26 of the main body 16. In short, the projection 74 and, thus, the tool 70, can only be installed in the fixture 10 in a single position based on the shape of the projection 74 and the shape of the aperture 26, which receives the projection 74.

When the projection 74 is sufficiently extended into the aperture 26. the projection 74 extends into the opening 20 and contacts the engagement surface 50. The projection 74 may include a series of projections and recesses (not shown) that mate with the engagement features 56 of the engagement surface (50) if the engagement features 56 are present on the engagement surface 50. Alternately. the projection 74 may include a distal end that is substantially flat. which engages the substantially flat engagement surface 50 of the adjustment dial 38. Once the projection 74 is in contact with the engagement surface 50 of the adjustment dial 38, a force may be applied to the adjustment dial 38 to rotate the adjustment dial 38 relative to the threaded rod 36 until a desired height of the tool 70 is achieved. Specifically. a rotational force may be applied to the adjustment dial 38 to move the adjustment dial 38 either toward or away from the top wall 32 depending on whether the tool 70 needs to be moved closer to or further from the top wall 32. Once the adjustment dial 38 is in a desired location relative to the threaded rod 36, a set screw 29 (FIG. 1) may be inserted into the through-hole 28 for engagement with the adjustment dial 38 to fix a position of the adjustment dial 38 relative to the main body 16.

The knob 40 may be attached to the threaded rod 36 to maintain a position of the tool 70 relative to the receiver 12. Specifically, the threads 68 of the nut 42 associated with the knob 40 may thread onto the threads 44 of the threaded rod 36 and may be rotated relative to the threaded rod 36 such that the knob 40 moves in a direction away from the first end 46 of the threaded rod 36 and toward the receiver 12. Once the knob 40 is sufficiently moved in a direction away from the first end 46 of the threaded rod 36. the knob 40 may contact the tool 70) to exert a force on the tool 70 between the knob 40 and the engagement service 50 of the adjustment dial 38. In short. the knob 40 and the engagement surface 50 of the adjustment dial 38 cooperate to clamp the tool 70 in a desired position relative to the receiver 12.

With the reference to FIG. 5. the fixture 10 is shown in conjunction with a plate 76 and a projection welder 78. The fixture 10 may be attached to the plate 76 via a series of fasteners 80. Specifically. the fasteners 80 may be received within respective apertures 34 of the flange 18 to attach the flange 18 and, thus, the receiver 12 to the plate 76. The projection welder 78 may likewise be attached to the plate 76 by inserting one or more fasteners 80) through a plate 82 of the projection welder 78 to attach the projection welder 78 to the plate 76. While the fixture 10 will be described hereinafter and shown in conjunction with a projection welder 78. the fixture 10 could be used to properly position the tool 70 and workpiece 72 relative to any external structure. For example, the fixture 10 may be used to properly position the tool 70 and workpiece 72 relative to a spot welder. for example.

When the fixture 10 is initially attached to the plate 76, and the tool 70 is inserted into the aperture 26 of the main body 16, a proper height of the tool 70 relative to the projection welder 78 may be achieved by rotating the adjustment dial 38 relative to and along the threaded rod 36. Namely, a height of the tool 70 relative to the projection welder 78 is determined by the position of the adjustment dial 38 along the threaded rod 36. As described above, the projection 74 of the tool 70 is in contact with and supported by the engagement surface 50 of the adjustment dial 38. Accordingly, movement of the adjustment dial 38 relative to and along the threaded rod 36 adjusts a height of the projection 74 and, thus, the tool 70 relative to the plate 76 and projection welder 78. When the projection 74 of the tool 70 is initially inserted into the aperture 26 of the main body 16 and contacts the adjustment dial 38, a position of the tool 70 relative to a welding tip 84 of the projection welder 78 may be observed. If the tool 70 is too close to the welding tip 84, a rotational force may be applied to the adjustment dial 38 to move the adjustment dial 38 in a direction toward the first end 46 of the threaded rod 36. In so doing, the engagement surface 50 of the adjustment dial 38 likewise moves in a direction toward the first end 46 of the threaded rod 36. Further, because the projection 74 of the tool 70) rests on and is supported by the adjustment dial 38, movement of the adjustment dial 38 in the direction toward the first end 46 of the threaded rod 36 likewise causes the tool 70 to move in a direction away from the plate 76. Once a proper position of the tool 70 relative to the projection welder 78 is achieved, the knob 40 may be rotated into engagement with the tool 70) to clap the tool 70 between the knob 40 and the engagement surface 50 of the adjustment dial 38.

The foregoing adjustability not only aides in adjusting a relative position between the tool 70 and the projection welder 78 during an initial setup of the tool 10, but further aides in adjustments required during manufacturing. For example, after a predetermined number of welds, the weld tip 84 typically requires maintenance. Such maintenance often results in material being removed from the weld tip 84 and, as such, a relative position between the weld tip 84 and the tool 70 needs to be adjusted to optimize a relative position between the tool 70 and the weld tip 84. Following material removal from the weld tip 84, the knob 40 may be removed from the threaded rod 36 and the adjustment dial 38 may be moved relative to and along the threaded rod 36 until the tool 70 is properly positioned relative to the weld tip 84. At this point, the knob 40 may be reattached to the threaded rod 36 to clamp the tool 70 between knob 40 and the engagement surface 50 of the adjustment dial 38.

With particular reference to FIG. 7, a fixture 10a is provided. In view of the substantial similarity in structure and function of the fixture 10a with respect to the fixture 10, like reference numerals are used hereinafter and in the drawings to identify like components while like components containing a letter extension are used to identify those components that have been modified.

As shown in FIG. 7, the fixture 10a, with exception of the receiver 12a and associated aperture 26a, is identical to the fixture 10. Specifically, the receiver 12a includes an aperture 26a having a different shape and/or orientation then the aperture 26 of the fixture 10. The different shape and/or orientation of the aperture 26a is specific to a tool 70a and projection 74a that are different than the tool 70 and projection 74 used in conjunction with the fixture 10. Using an aperture 26A that has a tool-specific aperture 26, 26a ensures that only the proper fixture 10, 10a is used in conjunction with the proper tool, 70, 70a. For example, the fixture 10 may not receive the projection 74a of the tool 70a, as the aperture 26 of the fixture 10 is rotated 180 degrees (180) relative to the aperture 26a of the fixture 10a. Providing the receiver 12, 12a with tool-specific apertures 26, 26a ensures that only the proper tool, 70, 70a is used with the proper fixture 10, 10a.

The foregoing fixtures 10, 10a provide a tool-specific solution that allows for easy adjustment of a position of a tool 70, 70a relative to an external structure such as, for example, a projection welder 78. Further, the fixtures 10, 10a allow for adjustment of a position of a tool 70, 70a relative to the projection welder 78 during the initial installation and following maintenance of the projection welder 78. Accordingly, the fixtures 10, 10a improve manufacturing efficiency and the ease with which maintenance of such a projection welder 78 is performed.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure. and all such modifications are intended to be included within the scope of the disclosure.

What is claimed is:

1. A fixture for supporting a tool, the fixture comprising:
a housing defining an aperture receiving a projection of the fixture;
a shaft extending through the aperture and into the housing, the shaft including a series of external threads; and
an adjustment dial threaded onto to the threads of the shaft and including an engagement surface in contact with a surface of the projection, the adjustment dial configured to adjust a position of the tool relative to the housing when the adjustment dial is rotated relative to and moves along the shaft.

2. The fixture of claim 1, wherein the shaft includes a first end projecting from the aperture and a second end disposed at an opposite end of the shaft than the first end and secured to the housing.

3. The fixture of claim 2, further comprising a knob threaded onto the shaft at the first end.

4. The fixture of claim 3, wherein the knob is configured to move along the shaft when rotated relative to the shaft, the knob moving in a direction toward the adjustment dial when rotated in a first direction to clamp the tool between the knob and the engagement surface when the adjustment dial is in a predetermined position relative to the housing.

5. The fixture of claim 1, wherein at least one of the housing and the adjustment dial is formed from a thermoplastic.

6. The fixture of claim 5, wherein the thermoplastic is Acrylonitrile Styrene Acrylate (ASA).

7. The fixture of claim 5, wherein at least one of the housing and the adjustment dial is formed via an additive manufacturing process.

8. The fixture of claim 1, further comprising a set screw supported by the housing, the set screw configured to engage an outer perimeter surface of the adjustment dial to fix a position of the adjustment dial relative to the housing.

9. The fixture of claim 1, wherein the aperture includes a shape that matingly conforms to a cross-sectional shape of the projection.

10. The fixture of claim 1, wherein a portion of the shaft extends through the tool proximate to the aperture.

11. A method for adjusting a position of a tool relative to a fixture, the method comprising:
providing a housing with an aperture;
extending a shaft through the aperture and into the housing, the shaft including a series of external threads;
threading an adjustment dial onto the threads of the shaft, the adjustment dial including an engagement surface;
extending a projection of the fixture through the aperture and into the housing;
contacting a distal end of the projection with the engagement surface of the adjustment dial;
rotating the adjustment dial relative to the housing to move the adjustment dial along the shaft; and
moving the tool relative to the housing along with the adjustment dial to adjust a position of the tool relative to the housing.

12. The method of claim 11, further comprising providing the shaft with a first end projecting from the aperture and a second end disposed at an opposite end of the shaft than the first end and secured to the housing.

13. The method of claim 12, further comprising threading a knob onto the shaft at the first end.

14. The method of claim 13, further comprising rotating the knob relative to the shaft to move the knob along the shaft, the knob moving in a direction toward the adjustment dial when rotated in a first direction to clamp the tool between the knob and the engagement surface when the adjustment dial is in a predetermined position relative to the housing.

15. The method of claim 11, further comprising forming at least one of the housing and the adjustment dial from a thermoplastic.

16. The method of claim 15, wherein forming at least one of the housing and the adjustment dial from a thermoplastic includes forming at least one of the housing and the adjustment dial from Acrylonitrile Styrene Acrylate (ASA).

17. The method of claim 15, further comprising forming at least one of the housing and the adjustment dial via an additive manufacturing process.

18. The method of claim 11, further comprising engaging an outer perimeter surface of the adjustment dial with a set screw to fix a position of the adjustment dial relative to the housing.

19. The method of claim 11, further comprising providing the aperture with a shape that matingly conforms to a cross-sectional shape of the projection.

20. The method of claim 11, further comprising extending a portion of the shaft through the tool proximate to the aperture.
